(19) United States
(12) Patent Application Publication
(10) Pub. No.: US 2026/0036951 A1
(43) Pub. Date: Feb. 5, 2026

(54) METHOD OF A CENTRAL CONTROLLER AND A CONTROLLER OF AN ENERGY STORAGE SYSTEM

(71) Applicant: VESTAS WIND SYSTEMS A/S, Aarhus N (DK)

(72) Inventors: Karthikeya Balladi RAGHUCHANDRA, Aarhus N (DK); Chris DAMGAARD, Herning (DK); Rouhollah Emami MEIBODI, Hinnerup (DK); Ugur SANCAR, Hinnerup (DK)

(21) Appl. No.: 19/101,431

(22) PCT Filed: Aug. 8, 2023
(86) PCT No.: PCT/DK2023/050199

§ 371 Date: Feb. 5, 2025

(30) Foreign Application Priority Data
Aug. 29, 2022 (DK) PA202270424

(51) Int. Cl. G05B 13/04; H02J 3/00

(52) U.S. Cl. CPC G05B 13/042; H02J 3/004; H02J 2203/20

(57) ABSTRACT

A method of a central controller, and a central controller, of an energy storage system for controlling two or more battery systems, wherein at least one of the two or more battery systems has at least one operation limitation are presented. The method comprises, and the central controller is configured for: -obtaining information related to the at least one operation limitation from the at least one battery system; -determining, based on the information, control parameters for the two or more battery systems, respectively, taking into account an estimation of how the at least one battery system with the at least one operation limitation will behave over time when being controlled by its control parameters; and -providing the control parameters to the two or more battery systems, respectively.

### TECHNICAL FIELD

Aspects of the present invention relate to a method of a central controller of an energy storage system for controlling two or more battery systems, to a central controller, to a power plant comprising the central controller, and to a computer program or a computer-readable medium.

### BACKGROUND

An energy storage system is used in power production and distribution systems to balance the supply and demand of power. Because of the difficulties to quickly adjust the power production of a power plant connected to a power grid, the power plant often includes an energy storage system utilized for matching the power provided by the power plant to the power consumption of the consumers connected to the power grid.

The energy storage system is thus utilized as an energy buffer, in which produced energy may be stored, for example during periods of surplus production of power in the power plant, until it is distributed to, and consumed in, the power grid, for example during periods of deficient power production. The energy storage system is, in other words, used for ensuring that there is a balance between the power supply from the power plant and the power consumption in the grid. The energy storage system is centrally controlled, for example by active and reactive power references distributed by a power plant controller (PPC), to the energy storage system. These active and reactive power references control the charge and discharge of power in the energy storage system.

Within the energy storage system, multiple battery systems are arranged for storing the electric energy. Each one of these battery systems comprises at least one power conversion system unit, at least one electric battery module, and at least one cooling system. The battery systems are controlled by control parameters provided by a central controller of the energy system. Such control parameters may comprise active and reactive power setpoints.

### SUMMARY

A drawback of conventional energy storage solutions is that they focus on the peak level and duration for the power charge and discharge of the battery systems. Also, the control of the battery systems of the energy storage systems is conventionally based on the assumption that all battery systems are equal. The capabilities of the individual battery systems are therefore not taken into account properly when the battery systems are controlled by the central controller.

This results in that the battery systems comprised in the energy storage system are not always utilized to their full potential, which causes difficulties for the energy system as a whole to provide the requested power levels, i.e. to supply the power levels corresponding to the power references provided by the plant controller.

An object of the present invention is to provide a solution which mitigates or solves the drawbacks and problems of conventional solutions.

The above and further objects are solved by the subject matter of the aspects of the independent claims. Further advantageous embodiments of the invention can be found in the dependent claims.

According to a first aspect of the invention, a method of a central controller of an energy storage system for controlling two or more battery systems, wherein at least one of the two or more battery systems has at least one operation limitation, is presented. The method comprises:
obtaining information related to the at least one operation limitation from the at least one battery system;
determining, based on the information, control parameters for the two or more battery systems, respectively, taking into account an estimation of how the at least one battery system with the at least one operation limitation will behave over time when being controlled by its control parameters; and
providing the control parameters to the two or more battery systems, respectively.

An advantage of the method according to the first aspect is that it makes it possible for the energy storage system to comply with power requests being requested/demanded by the power grid via the power plant controller, i.e. to comply with the power requested/demanded by usage of overall active and reactive power references. The method estimates how a battery system having an operation limitation, i.e. how a faulty battery system, will behave now and in the future, and uses this estimation to utilize the battery system to the best of its capabilities. Thus, instead of not using the battery system having an operation limitation at all, which would have been the case in conventional solutions, the faulty battery system is, according to the method, intelligently used while taking its operation limitations into consideration.

If it, for example, is estimated that one battery system, due to its operation limitation, sometime in the future would run into some kind of operational disruption if it would be controlled normally, i.e. if it would be controlled in the same way as the rest of the battery systems, then that specific battery may be individually controlled such that the operation disruption is avoided. However, the battery system is hereby utilized within its own operation limitations, such that it may contribute with its limited capacity to the total function of the energy storage system.

The method according to the first aspect thus provides for a customized utilization of individual battery systems having an operation limitation, which also can be described as a non-binary dispatch of control parameters. This is totally different from the conventional binary dispatch of control parameters, wherein a faulty battery system was simply not used. Thus, battery systems have traditionally either been utilized completely or not utilized at all, depending on its condition, i.e. a binary dispatch was used. Thus, since it in conventional solutions is not fully explored how each individual battery system can contribute to the energy storage system as a whole reaching the requested power levels, the energy storage system and its battery systems are traditionally not optimally utilized.

According to the first aspect, however, a partially defect battery system is partially utilized in accordance with its limited capacity, i.e. a customized/non-binary control parameter dispatch is achieved. Thus, an energy storage system utilizing the first aspect method, as a contrast to conventional solutions, takes the individual conditions for each one of the battery systems into consideration at the determination and dispatch of the control parameters . . . When controlling the battery systems according to the “plant perspective”, it is thus possible to, by taking into account the current conditions of the individual battery systems, not require maximum charge and discharge power capabilities from each one of the battery systems, and to instead tailor the requested power for the at least one faulty battery system to its limitations. By this intelligent and optimized control of the individual battery systems, the overall capacity of the energy storage system is increased.

According to an embodiment of the method according to the first aspect
the determination of the control parameters is performed such the at least one battery system with the at least one operation limitation is controlled to only be utilized during one or more of limited time periods and limited peak powers.

Hereby, the at least one battery system with the at least one operation limitation may be utilized such that the at least one battery system is not run totally out of order. If, for example, the at least one battery system is partially inoperable, the at least one battery system may, by this embodiment, be used during short time periods to avoid making it completely inoperable. Thus, the at least one battery system is controlled such that it may contribute to the power supply without breaking down, for example without being overheated.

According to an embodiment of the method according to the first aspect
the at least one operation limitation is associated with an at least partially malfunctioning cooling system of the at least one battery system; and
the determination of the control parameters is performed such that overheating of the at least one battery system with the at least one operation limitation is avoided when it is controlled by its control parameters.

Thus, by determining the control parameters according to the embodiment, the at least one battery system may be utilized within its capabilities, i.e. it may be used during such short time periods that the temperature is kept within safe and reasonable limits. Hereby, the at least one battery system can contribute to the power supply, i.e. can help the energy storage system to provide the requested power, but does still not risk to be overheated. This is due to the intelligent determination of the control parameters, which takes into account how the at least one battery system would behave over time due to its at least partially malfunctioning cooling system, i.e. which take into account how a temperature of the at least one battery system will develop over time when it is utilized.

According to an embodiment of the method according to the first aspect
the determination of the control parameters is based on a model, wherein the model describes how a temperature of the at least one battery system, due to the at least partially malfunctioning cooling system, will vary over time as a function of its control parameters.

By usage of this model, a robust and exact estimation of how the at least one battery system would behave over time, due to its at least partially malfunctioning cooling system, when being controlled by its control parameters. Hereby, a customized and precise control of the at least one battery system is made possible, utilizing the at least one battery system optimally within its limited capabilities/capacity.

According to an embodiment of the method according to the first aspect, the model is used for one of the group of:
a determination of the information related to the at least one operation limitation; and
the determination of the control parameters, utilizing the information related to the at least one operation limitation as an input to the model.

Thus, the model may be used within the at least one battery system for determining the operation limitation information and/or may be used within the central controller for determining the control parameters. Since the model may be used in various parts of the system, for various determinations, an implementation flexibility is provided. The usage of the model for these determinations results in an efficient and precise control of the two or more battery systems.

According to an embodiment of the method according to the first aspect
the at least one operation limitation is associated with the at least one battery system having a limited capability to provide active power; and
the determination of the control parameters is performed such that the at least one battery system with the at least one operation limitation is controlled to provide active power corresponding to its limited active power capability, and such that at least one power conversion system unit of the at least one battery system, respectively, is controlled to provide reactive power.

Hereby, the requested reactive power is handled by the faulty at least one battery system. For providing reactive power, the at least one battery unit does not have to be functioning, it is enough if the power conversion system unit is functioning. The other battery systems may then concentrate on providing the requested active power. Hereby, an increased capacity for active power may be provided by the energy storage system.

According to an embodiment of the method according to the first aspect, the at least one battery system is used for static synchronous compensation.

Hereby, the faulty battery system handles the reactive power such that the voltage in the power grid may be quickly regulated.

According to an embodiment of the method according to the first aspect
the determination of the control parameters is performed such that the at least one battery system with the at least one operation limitation is controlled to be inactivated in order to reduce an auxiliary power consumption of the energy storage system.

By the inactivation of the at least one faulty battery system, which may take place after it has been used within its operation limitation, its auxiliary power consumption is reduced to zero. This reduces the total auxiliary power consumption of the energy storage system and makes more power available for supply to the power grid.

According to an embodiment of the method according to the first aspect
the determination of the control parameters is performed such that the at least one battery system with the at least one operation limitation is controlled to perform a battery condition test.

It is important to know the state of charge (SOC) and the state of health (SOH) of the battery units of the battery systems. Therefore, repeated testing of the battery systems should be performed. According to this embodiment, the testing is performed when the at least one battery system has an operation limitation anyway, wherefore the testing itself does not affect the capacity of the energy storage system. Thus, since the at least one battery system is faulty anyway, and is therefore used only within its limited capabilities, testing may be performed without further reducing the capacity of the energy storage system.

According to an embodiment of the method according to the first aspect, the control parameters comprise one or more of the group of:
active power setpoints; and
reactive power setpoints.

According to the embodiment, active power setpoints and reactive power setpoints are provided from the central controller to the two or more battery systems. Hereby, the requested power demand may be distributed to, and handled by, multiple battery systems. This provides for a flexible tree-structured system comprising multiple levels of control between central controllers and battery systems. The energy storage system may hereby be expanded, such that more battery systems are added and controlled using such active power setpoints and reactive power setpoints.

According to an embodiment of the method according to the first aspect, the information related to the at least one operation limitation comprises information related to one or more of the group of:
an actual state of the least one battery system;
a performance of a cooling system of the at least one battery system;
a uniformity of rack status of a battery unit of the at least one battery system;
an off gas condition of a battery unit of the at least one battery system;
a maximal active power capability of the least one battery system;
a condition of at least one power conversion system unit of the least one battery system;
an insulation status of the least one battery system; and
a thermal performance of a battery unit of the at least one battery system.

Thus, information related to the at least one operation limitation may comprise information related to a number of different states and/or conditions in the battery systems. Hereby, a correct estimation of how the at least one battery system with the at least one operation limitation will behave over time may be performed. Generally, if more information is available for the estimation this increases the quality of the estimation. Also, in various moments/situations, various types of information results in the most correct estimation, wherefore it is advantageous to be able to base the estimation on various types of information. Thus, the embodiment provides for a flexible estimation of behavior having high accuracy.

According to an embodiment of the method according to the first aspect
the determination of the control parameters for the two or more battery systems, respectively, provides for a condition-based control parameter distribution of a remaining useful power between the two or more battery systems over time, taking into account the at least one operation limitation of the at least one battery system.

Such a condition-based control parameter distribution/dispatch makes it possible for a faulty battery system to contribute with its limited capacity to the overall function of the energy storage system. Thus, a customized utilization of individual battery systems having an operation limitation is provided, such that the overall capacity of the energy storage system is increased.

According to a second aspect of the invention, a central controller of an energy storage system configured to control two or more battery systems, where at least one of the two of more battery systems has at least one operation limitation, is presented. The central controller is configured to:
obtain information related to the at least one operation limitation from the at least one battery system;
determine, based on the information, control parameters for the two or more battery systems, respectively, taking into account an estimation of how the at least one battery system with the at least one operation limitation will behave over time when being controlled by its control parameters; and
provide (430) the control parameters to the two or more battery systems, respectively.

The central controller of the second aspect has corresponding advantages as the ones mentioned above for the method of the central controller according to the first aspect of the invention.

It is to be appreciated that all the embodiments described for the method aspect of the invention are applicable also to the central controller aspect of the invention. Thus, all embodiments described for the method aspect of the invention may be performed by the central controller, which may include one or more controllers, control units, or control devices. The embodiments of the central controller have advantages corresponding to advantages mentioned above for the method and its embodiments.

According to a third aspect of the invention, a power plant configured to provide electric power to an electric power grid is presented. The power plant comprises:
one or more electric power generating units;
two or more battery systems; and
a central controller as herein described.

The power plant of the third aspect has corresponding advantages as the ones mentioned above for the method of the central controller according to the first aspect of the invention and its embodiments.

According to a fourth aspect of the invention, the above mentioned and other objects are achieved with a computer program or a computer-readable medium comprising instructions which, when the program or the instructions is/are executed by a computer, cause the computer to carry out one or more of the method according to any one of the aspects and embodiments disclosed above or below. Advantages of the computer program or the computer-readable medium according to the fourth aspect correspond to advantages of the method according to the first aspect and its embodiments mentioned above or below.

According to an aspect of the present invention, the above-mentioned computer program and/or the computer-readable medium are/is configured to implement the method and its embodiments described herein.

The above-mentioned features and embodiments of the method, the central controller, the power plant, the computer program, and the computer-readable medium, respectively, may be combined in various possible ways, thereby providing further advantageous embodiments.

Further advantageous embodiments of the method, the central controller, the power plant, the computer program, and the computer-readable medium according to the present invention, and further advantages of the embodiments of the present invention, emerge from the detailed description of embodiments.

### BRIEF DESCRIPTION OF THE DRAWINGS

Aspects and embodiments of the invention are illustrated, for exemplary purposes, in more detail by way of embodiments and with reference to the enclosed drawings, where similar references are used for similar parts, in which:

FIG. 1 is a schematic diagram illustrating an example of a power plant, in which aspects and embodiments of the present invention may be implemented;

FIG. 2 is a schematic diagram illustrating an energy storage system, in which aspects and embodiments of the present invention may be implemented;

FIG. 3 is a schematic diagram illustrating an energy storage system, in which aspects and embodiments of the present invention may be implemented;

FIG. 4 is a flow chart diagram illustrating the method according to the first aspect of the present invention, and some of its embodiments;

FIG. 5 is a schematical and functional illustration of an example use of some embodiments of the present invention;

FIG. 6 is a schematical and functional illustration of an example use of some embodiments of the present invention;

FIG. 7 is a schematical and functional illustration of an example use of some embodiments of the present invention;

FIG. 8 is a schematical and functional illustration of an example use of some embodiments of the present invention;

FIG. 9 is a schematic diagram illustrating an embodiment of the central controller according to the second aspect of the invention, in which a method according to any one of the herein described aspects and embodiments may be implemented.

### DETAILED DESCRIPTION

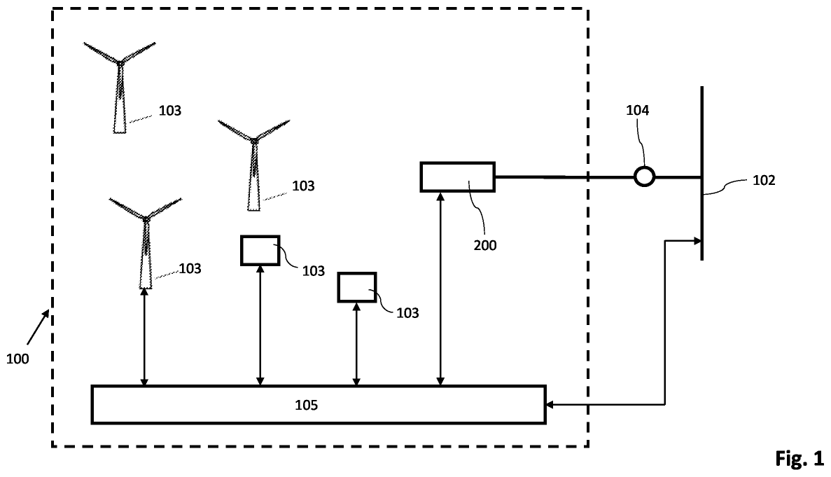

FIG. 1 schematically illustrates a non-limiting example of a power plant 100, in which aspects and embodiments of the present invention may be implemented. The aspects and embodiments of the present invention may, of course be implemented in any essentially solution, in which an energy storage system us used, and is not limited to implementation in the power plant example in FIG. 1, or in power plants as such.

The power plant 100 is arranged for providing electric power, or electrical energy, to an electric power grid 102. The power plant 100 includes one or more electric power generating units 103. According to some embodiments, the one or more electric power generating units 103 may include one or more of the group of: a wind turbine generator, a photo-voltaic panel, and a fuel cell. The wind turbine generators, the photo-voltaic panels, and the fuel cells may also be generally described as power sources 103 of the power plant 100, or as power generators 103 of the power plant 100. The power plant 100 also includes an energy storage system 200, described more in detail below.

The power plant 100 may be connected, or connectable, to the electric power grid 102 via a point of common coupling (PCC) 104. For some embodiments, the electric power grid 102 may be referred to as a utility grid, an electrical grid, or an electric power network. For example, the power plant 100 may be located offshore or on land.

The power plant 100 includes a control arrangement 105 configured to control the power plant 100. According to some embodiments, the control arrangement 105 may comprise, or be referred to as, a power plant controller (PPC). As schematically illustrated in FIG. 1, the power plant controller 105 controls the power generating units 103 and the energy storage system 200. The energy storage system 200 may here be controlled by power references being provided by the power plant controller, which is explained more in detail below.

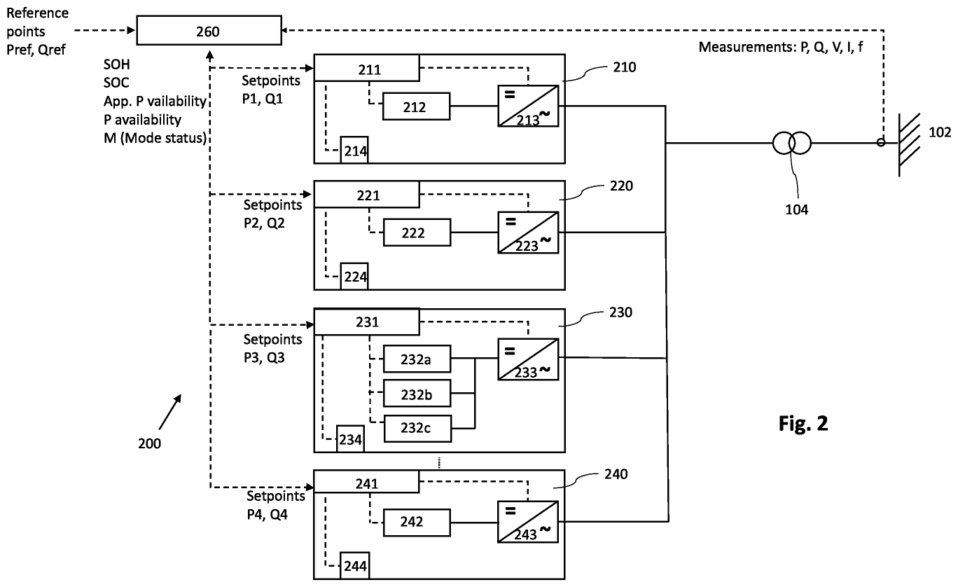

FIG. 2 schematically illustrates a non-limiting example of at least part of an energy storage system 200, in which the aspects and embodiments of the present invention may be implemented. The aspects and embodiments of the present invention may, however, be implemented in any essentially energy storage system, and are not limited to the one shown in FIG. 2.

The energy storage system illustrated in FIG. 2 comprises, as an example, a first 210, a second 220, a third 230 and a fourth 240 electric battery system. As is understood by a skilled person, the energy storage system 200 may comprise any number of two or more battery storage systems 210, 220, 230, 240. Each one of the battery systems 210, 220, 230, 240 comprises at least one power conversion system unit 213, 223, 233, 243 and at least one battery unit 212, 222, 232a-c, 242. As schematically illustrated e.g. in the first battery system 210, one battery unit 212 may be associated/coupled with/to one power conversion system unit 213. However, as schematically illustrated in the third battery system 230, two or more battery units, here illustrated as three battery units 232a, 232b, 232c, may also be associated/coupled with/to one power conversion system unit 233. Further, although not shown for readability reasons in FIG. 1, a battery system may also comprise two or more power conversion system units, where each one of these two or more power conversion system units may be associated/coupled with/to one or more battery unit. The power conversion system units 213, 223, 233, 243, comprising converters, are arranged for converting DC power from the battery units 212, 222, 232a-c, 242 to AC power to be provided to the electric power grid 102, and for charging and discharging the battery units 212, 222, 232a-c, 242.

Each one of the battery systems 210, 220, 230, 240 may further comprise a functional unit 214, 224, 234, 244, such as for example a cooling system, i.e. a thermal system arranged to regulate the temperature of the battery system 210, 220, 230, 240 such that safe operation is ensured. Each one of the battery systems 210, 220, 230, 240 further comprises a local controller 211, 221, 231, 241, configured to control the battery unit 212, 222, 232a-c, 242, the power conversion system unit 213, 223, 233, 243 and the functional unit 214, 224, 234, 244.

The energy storage system 200 further comprises a central controller 260, which is configured to control each one of the battery systems 210, 220, 230, 240. The central controller is provided with active and reactive power reference points Pref, Qref, originating from the power plant controller 105. The central controller 260 may also be provided with information related to measurements in the grid 102, for example including information related to one or more of active power P, reactive power Q, voltage V, current I, and frequency f measurements. The central controller 260 may also be provided with information from the battery systems 210, 220, 230, 240 including information related to one or more of state of health (SOH), state of charge (SOC), mode status (M), apparent power availability and active power availability for the individual battery systems 210, 220, 230, 240. Based on these inputs, i.e. based on its available information, the central controller determines and distributes setpoints P1, Q1; P2, Q2; P3, Q3; P4, Q4 to the battery systems 210, 220, 230, 240, respectively. Thus, each one of the battery systems 210, 220, 230, 240 is provided with individual setpoints from the central controller 260. In this document, the mentioned P-setpoints P1, P2, P3, P4, P5 may be active power setpoints, and the mentioned Q-setpoints Q1, Q2, Q3, Q4, Q5 may be reactive power setpoints. Hereby, the function of each one of the battery systems 210, 220, 230, 240 is controlled by the central controller. The central controller 260 may at least partly be comprised/incorporated in the power plant controller 105. The central controller may also at least partly be arranged separate from the power plant controller, and is then controlled by the power plant controller 105 via the reference points Pref, Qref.

According to some embodiments, the central controller 260 is configured to control any controllable unit within the battery systems 210, 220, 230, 240. This may for example be the smallest controllable unit of the battery systems 210, 220, 230, 240, such as the battery systems 210, 220, 230, 240 themselves, central power conversion system units 213, 223, 233, 243 of the battery systems, or multiple distributed power conversion units of the battery systems. There may thus be one or more controllable units within each one of the battery systems 210, 220, 230, 240, and the central controller 260 is configured to control these controllable units.

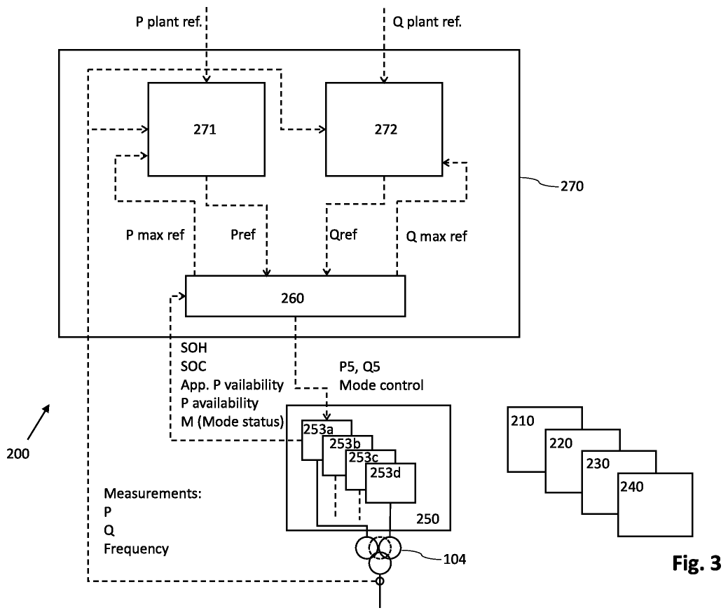

FIG. 3 schematically illustrates a slightly more detailed non-limiting example of an implementation of a central controller 260 and some battery systems 210, 220, 230, 240, 250 in an energy storage system 200. In this example, the central controller 260 is arranged in an electric management system EMS 270, which may at least partly be comprised in the power plant controller 105. The electric management system 270 further comprises an active power controller 271 and a reactive power controller 272.

The active power controller 271 obtains active power plant references from the power plant controller 105 and active power maximum references from the central controller 260. Correspondingly, the reactive power controller 272 obtains reactive power plant references from the power plant controller 105 and reactive power maximum references from the central controller 260. The active and reactive power plant references are distributed to all corresponding electric management systems in the power plant 100. The active power controller 271 and the reactive power controller 272 also obtain power grid measurement related to one or more of active power, reactive power and frequency. Based on these inputs, the active power controller 271 calculates active power references Pref and the reactive power controller 272 calculates reactive power references Qref, that are provided to the central controller 260.

The central controller controls two or more schematically illustrated battery systems 210, 220, 230, 240, 250, of which the first 210, the second 220, the third 230 and the fourth 240 battery systems are described in connection with FIG. 1. The fifth battery system 250 comprises four power conversion system units 253a, 253b, 253c, 253d in the example shown in FIG. 3. Each one of these four power conversion system units 253a, 253b, 253c, 253d may be be associated/coupled with/to one or more battery units (not shown). The fifth battery system 250 also comprises at least one functional unit (not shown), e.g. at least one cooling system, and a local controller (not shown), configured to control the power conversion systems, the battery units and the at least one functional unit.

The central controller 260 may here control the battery systems 210, 220, 230, 240, 250 as described above in connection with FIG. 2. Thus, based on the active power references Pref and the reactive power references Qref, and other inputs obtained by the central controller 260, the central controller 260 determines and provides individual setpoints P1, Q1; P2, Q2; P3, Q3; P4, Q4; P5, Q5 to the battery systems 210, 220, 230, 240, 250, respectively. Thus, each one of the battery systems 210, 220, 230, 240, 250 is provided with individual setpoints P1, Q1; P2, Q2; P3, Q3; P4, Q4; P5, Q5 from the central controller 260, such that the function of each one of the battery systems 210, 220, 230, 240, 250 is controlled by the central controller 260, which in its turn is controlled by the power plant controller 105.

As mentioned above, the herein described, and in FIGS. 2 and 3 schematically illustrated, battery systems 210, 220, 230, 240, 250 each comprises at least one local controller, one or more power conversion system unit, and at least one battery unit. The battery systems 210, 220, 230, 240, 250 may also comprise at least one functional unit. Each one of the one or more power conversion units may be associated with at least one battery unit. For example, the battery systems 210, 220, 230, 240, 250 may correspond to, or may be comprised in a battery energy storage system (BESS) unit, which for example may be located in a container. The central controller 260 is configured to control the battery systems 210, 220, 230, 240, 250 by controlling their controllable units, e.g. each one of the battery systems as such, or one or more power conversion system units within each battery system.

Generally, a control system arranged for controlling the battery systems 210, 220, 230, 240, 250 receives power reference values from a power grid operator of the power grid. The control system then controls the battery systems 210, 220, 230, 240, 250 based on these power reference values, wherein this control may utilize one or more controllers. Thus, the control system might comprise one central controller, or might comprise a string of two or more controllers, arranged for controlling the battery systems 210, 220, 230, 240, 250.

The herein mentioned power plant controller (PCC) and energy management systems (EMS) may operate at the same logical level in the control system, having at least partly different inputs and providing information to each other. For example, the power plant controller may generate an internal park reference, which is then split up and sent to the various assets/entities in the park, such as to two or more energy management systems in the part. For example, the active (P plant ref) and reactive (Q Plant ref) power plant references in the top of FIG. 3 may be such split-up references/setpoints. Each energy management system may then comprise a hierarchy of one or more internal controllers that will send each other information and commands in order to comply with the received references/setpoints.

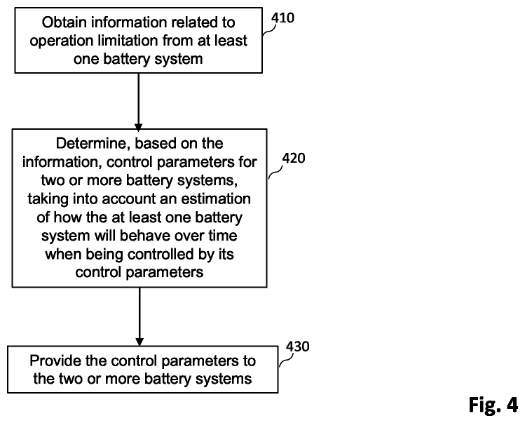

FIG. 4 shows a flow chart diagram for a method according to the first aspect of the present invention. The method discloses how the central controller 260 controls two of more battery systems 210, 220, 230, 240, when at least one of the two or more battery systems, for example the second battery system 220, has at least one operation limitation. Thus, at least one 220 of the two of more battery systems 210, 220, 230, 240 is at least partly faulty or malfunctioning, for example due to that at least one functional unit 214, 224, 234, 244 is not functioning/operating properly.

In a first step 410, the central controller obtains information M related to the at least one operation limitation. This information M is provided by the at least one battery system 220 having the operation limitation. For example, if the functional unit 224 of the second battery system 220 is out of order, i.e. is faulty in some way, then the local controller 221 of the second battery system 220 provides information regarding this operation limitation to the central controller 260. The operation limitation may also be related to the battery system 220 as a whole or to one or more parts of the battery system 220, such as e.g. at least one power conversion system unit 223 and/or at least one battery unit 222. The operation limitation of the at least one battery system 220 may vary over time, depending on a number of factors, such as for example the type of operation limitation, the ambient temperature or other operation conditions. During a time period of one or more hours, or even during time periods shorter than an hour, the condition of the battery system 220 may change, resulting in a changing operation limitation. The information related to the at least one operation limitation may e.g. be included in a mode status report M provided from the second battery system 200 to the central controller 260 (illustrated in FIGS. 2 and 3). The mode status report M may for example comprise one or more of error indications, ready indications, start-up indications, operation indications, and operation limitation indications.

In a second step 420, the central controller 260 determines, based on the information M related to the at least one operation limitation, control parameters P1, Q1; P2, Q2; P3, Q3; P4, Q4, such as active and reactive power setpoints, for the two or more battery systems 210, 220, 230, 240, respectively. Thus, for the example illustrated in FIG. 2, first individual control parameters P1, Q1 are determined for the first battery system 210, second individual control parameters P2, Q2 are determined for the second battery system 220, third individual control parameters P3, Q3 are determined for the third battery system 230, and fourth individual control parameters P4, Q4 are determined for the fourth battery system 240. The determination of the control parameters P1, Q1; P2, Q2; P3, Q3; P4, Q4 is based on an estimation of how the at least one battery system 220 with the at least one operation limitation would behave over time when being controlled by its control parameters P2, Q2. It is thus predicted how the at least one faulty battery system 220 would behave, now and in the future, if it would be controlled by utilization of its control parameters P2, Q2. This prediction then forms a basis for the determination of the control parameters P1, Q1; P2, Q2; P3, Q3; P4, Q4 for the two or more battery systems 210, 220, 230, 240. As is understood by a skilled person, the determination of the control parameters P1, Q1; P2, Q2; P3, Q3; P4, Q4 is, in addition to the information M related to the operation limitation, also based on one or more of the inputs to the central controller mentioned in connection with FIGS. 2 and 3 above.

In a third step 430, the determined control parameters P1, Q1; P2, Q2; P3, Q3; P4, Q4 are provided to the two or more battery systems 210, 220, 230, 240, respectively. Thus, each one of the two or more battery systems 210, 220, 230, 240 are provided with their individual control parameters. These control parameters P1, Q1; P2, Q2; P3, Q3; P4, Q4 are then utilized by the local controllers 211, 221, 231, 241 in each of the battery systems 210, 220, 230, 240 to control one or more of the power conversion system units 213, 223, 233, 243, the battery units 212, 222, 232a-c, 242 and the functional units 214, 224, 234, 244.

Hereby, i.e. by taking into account an estimation/prediction of how the at least one faulty battery system 220 will work when controlled by its control parameters, a customized usage of the faulty battery system 220 is possible. Thus, the faulty battery system can then be used within its operation limitations, which results in an overall more optimal usage of the battery systems.

As explained more in detail below, the control parameters P1, Q1; P2, Q2; P3, Q3; P4, Q4 may comprise active power setpoints P and reactive power setpoints Q. These active P and reactive Q power setpoints are used for controlling both charging and discharging of the battery systems 210, 220, 230, 240, i.e. of the battery units comprised in the battery systems 210, 220, 230, 240. These setpoints may have positive or negative values.

Positive-valued active setpoints control/provide charging of the battery systems 210, 220, 230, 240, whereas negative-valued active setpoints control/provide discharging of the battery systems 210, 220, 230, 240. Positive-valued reactive setpoints provide reactive power to the battery systems 210, 220, 230, 240, e.g. if the reactive power is leading, whereas negative-valued reactive setpoints consume reactive power in the battery systems 210, 220, 230, 240, i.e. if the reactive power is lagging.

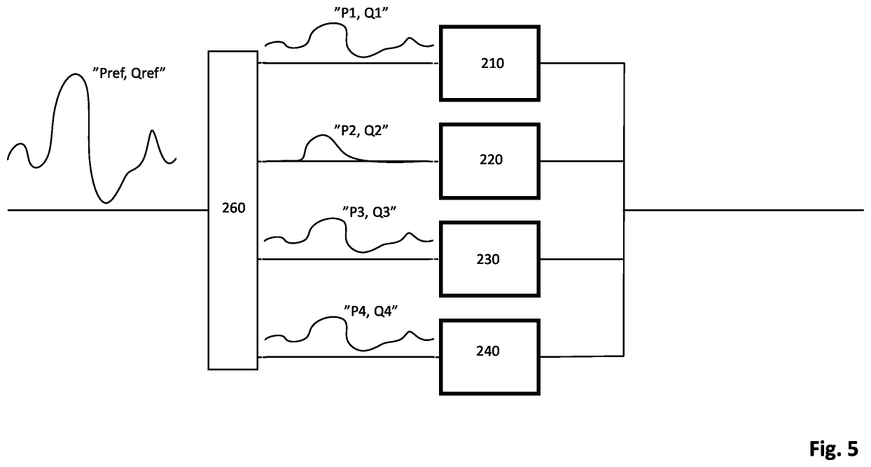

FIGS. 5-8 are schematical and functional illustrations of examples of how some embodiments of the present invention may be used if there is a fault in one 220 of the battery systems 210, 220, 230, 240. In these figures, requested power over time is illustrated as a curve, denoted “Pref, Qref” in the figure, corresponding to active and reactive power reference points Pref, Qref originating from the plant controller 105, is divided into four curves “P1, Q1”; “P2, Q2”; “P3, Q3”; “P4, Q4” each illustrating requested power over time, corresponding to active and reactive power setpoints P1, Q1; P2, Q2; P3, Q3; P4, Q4, respectively, requested/demanded from the four battery systems 210, 220, 230, 240 by a central controller 260. Thus, FIGS. 5-8 schematically and functionally illustrates how a common power request Pref, Qref to the energy storage system is divided into individual power setpoints P1, Q1; P2, Q2; P3, Q3; P4, Q4 for the battery systems 210, 220, 230, 240, respectively. It is, in other words illustrated how the common power request Pref, Qref is distributed over the battery systems 210, 220, 230, 240.

FIGS. 5-8 illustrate, as an example, four battery systems 210, 220, 230, 240, of which one battery system 220 is at least partly faulty. However, as understood by the skilled person, the principles illustrated in these figures are easily expanded to the more general aspects and embodiments herein described, wherein more than four battery systems, of which more than one may be faulty, may be controlled by the central controller 260.

According to the embodiment, illustrated in FIG. 5, the central controller 260 takes into account an estimation of how the at least one battery system 220 with the at least one operation limitation will behave over time when being controlled by its control parameters P2, Q2, such that the faulty battery system 220 is controlled to be utilized within its limitations. Hereby, the determination 420 of the control parameters/setpoints P1, Q1; P2, Q2; P3, Q3; P4, Q4 is performed such the at least one battery system 220 with the at least one operation limitation is controlled to only be utilized during limited time periods and/or limited peak powers. Hereby, the faulty battery system 220 is only utilized temporally/intermittently when it is really needed, for example to provide short power boosts at peak power, as illustrated in FIG. 5, and within its operation limitations.

The faulty battery system 220 is then controlled such that it may contribute to the overall power supply, without risk of e.g. overheating the faulty battery system 220. The central controller 260 further determines control parameters, i.e. determines sets of active and reactive power set points P1, Q1; P3, Q3; P4, Q4 for the other battery systems 210, 230, 240, such that the rest of the requested power, i.e. the total requested power “Pref, Qref” minus the power portion controlled to the faulty battery system 220 by its control parameters P2, Q2, is divided over the other battery systems 210, 230, 240.

Traditionally, in conventional systems, a central controller 260 would not have used the faulty battery system 220 at all, and had instead divided the total requested power over time “Pref, Qref” into three essentially equal distributed curves illustrating requested power over time “P1, Q1”; “P3, Q3”; “P4, Q4” over the other battery systems 210, 230, 240. Thus, three sets of control parameters, i.e. three sets of active and reactive power set points P1, Q1; P3, Q3; P4, Q4, would traditionally be assigned essentially the same values, each corresponding to a third of the total requested power, and the faulty battery system 220 had not be used at all. Obviously, the embodiment of the present invention provides for a more efficient use of the available battery systems 210, 220, 230, 240, especially of the faulty battery system 220.

According to an embodiment, the at least one operation limitation of the faulty battery system 220 is associated with an at least partially malfunctioning cooling system 224. Thus, the functional unit 224 of the faulty battery system 220 is here a cooling system, i.e. a temperature regulating system, which is not working properly.

The information M being provided by the at least one battery system 220 to the central controller 260 is then related to the operation limitations of the faulty cooling system 224. Hereby, the central controller 260 obtains information related to in which way the cooling system 224 is faulty/malfunctioning/inoperable and possibly also related to how this affects the temperature regulation of the battery system 220, i.e. how it affects the cooling performance of the cooling system 224.

The central controller 260 utilizes this operation limitation information M as a basis for the determination 420 of the control parameters P1, Q1; P2, Q2; P3, Q3; P4, Q4 for the two or more battery systems 210, 220, 230, 240. Hereby, it is possible to perform the determination 420 of the control parameters P1, Q1; P2, Q2; P3, Q3; P4, Q4 such that overheating of the at least one battery system 220 with the at least one operation limitation is avoided when it is controlled by its control parameters P2, Q2. Since the central controller then may base the determination of the control parameters P1, Q1; P2, Q2; P3, Q3; P4, Q4 on the estimation/prediction of how the cooling system 224, and thus also the battery system 220, would behave over time as a result of its control parameters P2, Q2, the battery system can be controlled to be used such that its temperature becomes close to, but not over, a maximally allowed temperature Tmax. Alternatively, the temperature may be intentionally controlled to exceed the maximally allowed temperature Tmax, but in a closely regulated and safe way.

In other words, since the central controller 260 knows how the faulty battery system 220 will behave, it can also exploit and use the faulty battery system within its limitations, such that unwanted overheating is not caused although the faulty battery system is kept in operation. This may be achieved by only utilizing the faulty battery system 220 at short time periods and/or at peak powers, as illustrated in FIG. 5. Hereby, an optimal and robust usage of a battery system 220 having operation limitations is achieved.

According to an embodiment, the determination 420 of the control parameters P1, Q1; P2, Q2; P3, Q3; P4, Q4 for the battery systems 210, 220, 230, 240, respectively, is based on a model, i.e.—is a model-based determination. This model describes how the temperature of the faulty battery system 220, which is the result of the at least partially malfunctioning cooling system 224, will vary over time as a function of its control parameters P2, Q2. The model may thus comprise information related to the thermal behavior of the abnormal battery system 220. The model may be used for the estimation of the behavior of the faulty battery system 220 now and in the future, when it is controlled by its control parameters, i.e. by its active and reactive power setpoints P2, Q2. Thus, the model is, according to the embodiment, used for determining how an at least partly faulty battery system can still be utilized, despite of its operation limitations.

The model may, according to various embodiments, be in the form of a statistically developed model, a laboratory developed model, a physical model, a look-up table, a graph, or essentially any other type of thermal presentation indicating how a temperature of a battery system varies over time as a function of its control parameters P2, Q2. The model may be determined based on measurements of normal behavior of a battery system and on measurements of its behavior when it has at least one operation limitation, e.g. when its cooling system 224 is faulty.

The model may, according to an embodiment, be used by the central controller 260, for the determination 420 of the control parameters P1, Q1; P2, Q2; P3, Q3; P4, Q4, wherein the obtained information M related to the at least one operation limitation is used as an input to the model. According to other embodiments, the model may also be used for the determining information M related to the at least one operation limitation, wherein the model is used at least in the local controller 221 of the faulty battery system 220.

As non-limiting numerical examples, it may be mentioned that if a battery system with properly working cooling system can operate at power P for 60 minutes, then the faulty system battery can operate at power P for 17 minutes. If the properly working battery system can operate at twice power 2P for 28 minutes, then the faulty system battery can operate at this power 2P for 6 minutes. If the properly working battery system can operate at three times power 3P for 12 minutes, then the faulty system battery can operate at this power 3P for 1 minute. These are just non-limiting numerical example values, given to illustrate the knowledge of the central controller, e.g. included in the model, which is utilized at the determination 420 of the control parameters so make sure that the faulty battery system may be safely utilized, but is not utilized such that it is overheated.

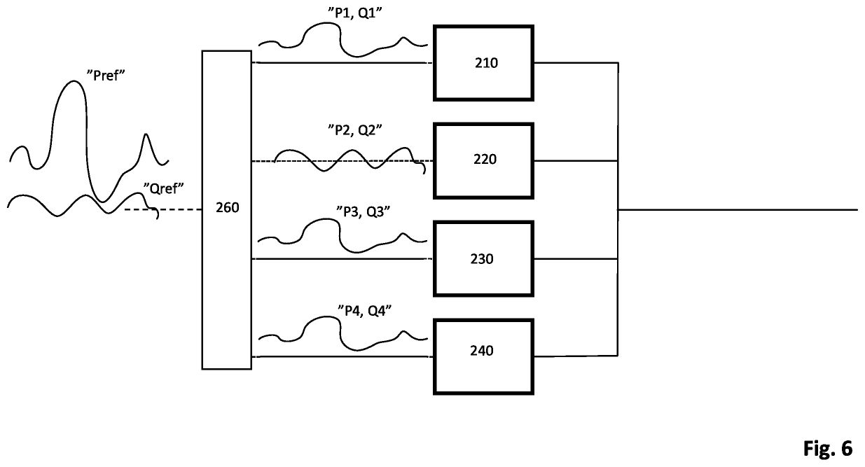

FIG. 6 is a schematical and functional illustration of an example of how an embodiment of the present invention may be used if there is a fault in one 220 of the battery systems 210, 220, 230, 240, where the fault is associated with a limited capability of the battery system 220 to provide active power. It is illustrated how a requested power over time, denoted “Pref, Qref”, including both active power and reactive power, is distributed over four battery systems 210, 220, 230, 240 by a central controller 260 according to the embodiment.

According to the embodiment, the control parameters P1, Q1; P2, Q2; P3, Q3; P4, Q4 for the battery systems 210, 220, 230, 240 are determined such that the battery system 220 with the limitations regarding providing active power is controlled, by its control parameters P2, Q2 to provide active power corresponding to its limited active power capability. Also, a power conversion system unit 223 of that battery system 220 is further controlled to provide reactive power. As is well known by a skilled person, reactive power may be used for controlling a voltage level of the power in the grid, whereas active power may be used for controlling the frequency of the power in the grid.

In the example illustrated in FIG. 6, the faulty battery system 220, is incapable to provided active power at all. Therefore, the control parameters P2, Q2 to the faulty battery system 220 controls the faulty battery system to only provide the reactive power of the requested power. Thus, the reactive power setpoints Q2 provided to the faulty battery system 220 from the central controller 260 corresponds to the requested reactive power references Qref being provided to the central controller 260 and originating from the power plant controller 105.

Thus, the faulty battery system 220 may, for example, take care of all the requested reactive power, as in the illustration of FIG. 6. According to an embodiment, the faulty battery system 220 is hereby used as a static synchronous compensation. When the faulty battery system 220 takes care of the requested reactive power, the other battery systems 210, 230, 240 are free to handle the requested active power, which may result in a higher overall active power capability of the energy storage system 200.

FIG. 6 is an illustration of how this embodiment may be implemented. One alternative implementation would be to combine this embodiment with the embodiment shown in FIG. 5. The reactive power may then be controlled by the central controller 260 such that it is provided after the peak power burst provided by the faulty battery system 220 in FIG. 5. Thus, in FIG. 5, a curve illustrating reactive power would then be added after the peak in the “P2, Q2”-curve.

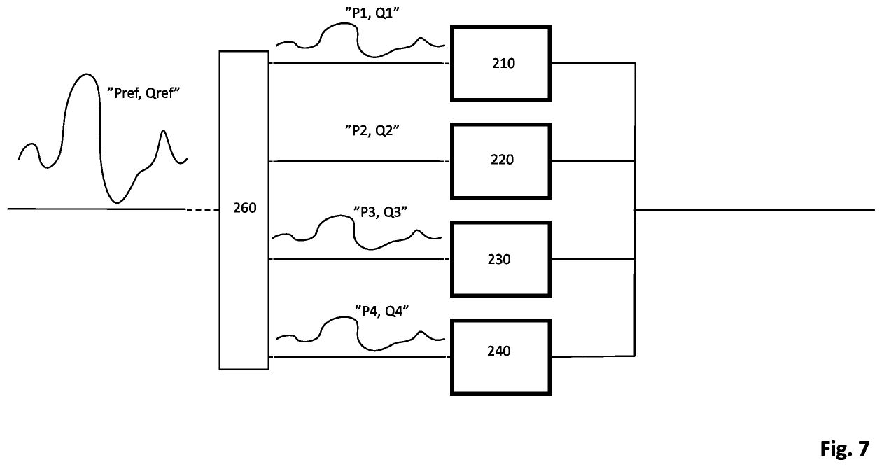

FIG. 7 is a schematical and functional illustration of an example of how an embodiment of the present invention may be used if there is a fault in one 220 of the battery systems 210, 220, 230, 240. It is illustrated how a requested power over time, denoted “Pref, Qref” is distributed over four battery systems 210, 220, 230, 240 by a central controller 260 according to the embodiment.

According to the embodiment, the determination 420 of the control parameters P1, Q1; P2, Q2; P3, Q3; P4, Q4 is performed such that the faulty battery system 220 is controlled to be inactivated in order to reduce an auxiliary power consumption of the energy storage system 200. This is in FIG. 7 illustrated as a zero-valued curve “P2, Q2” for the faulty battery system 220.

Thus, after the faulty battery system 220 has been used within its operation limitation, and is thereafter chosen not to be used any more in the energy storage system 200, the faulty battery system 220 should be inactivated. By the inactivation of the faulty battery system 220, i.e. by the shutdown of the faulty battery system 220, its power consumption is reduced to zero. Hereby, the total auxiliary power consumption, e.g. the power consumption for the local controller 221, for the cooling system 224, for the power conversion system unit 233, and for other possible parts of the battery system, is reduced to zero for the faulty battery system 220. Basically, all auxiliary power otherwise consumed by surveillance and monitoring, as well as by power used for energizing transformers and the like in the faulty battery system 220, may then instead be supplied to the power grid 102.

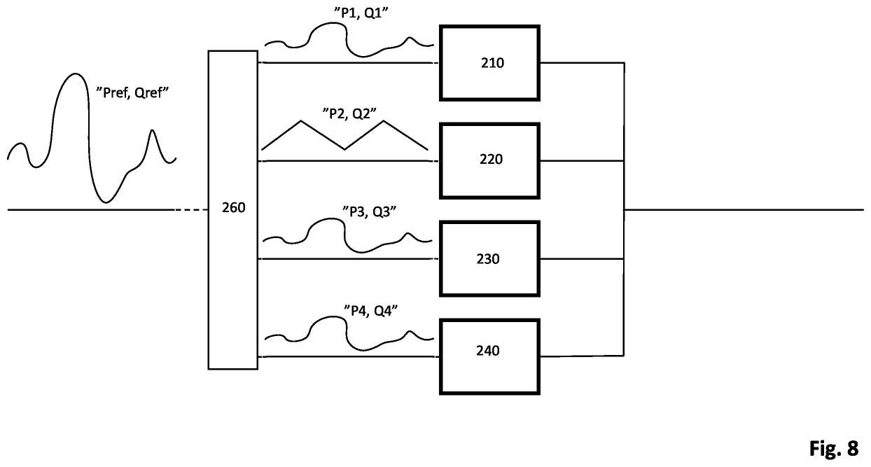

FIG. 8 is a schematical and functional illustration of an example of how an embodiment of the present invention may be used if there is a fault in one 220 of the battery systems 210, 220, 230, 240. It is illustrated how a requested power over time, denoted “Pref, Qref” is distributed over four battery systems 210, 220, 230, 240 by a central controller 260 according to the embodiment.

According to the embodiment, the determination 420 of the control parameters P1, Q1; P2, Q2; P3, Q3; P4, Q4 is performed such that the faulty battery system 220 is controlled by its control parameters, i.e. by its active and reactive power setpoints P2, Q2, to perform a battery condition test, i.e. to perform a test of at least one of its one or more battery units 222. This is in FIG. 8 schematically illustrated as a sawtooth formed test curve “P2, Q2” for the faulty battery system 220. The other battery systems 210, 230, 240 are controlled to handle the requested active and reactive power. Thus, the requested active and reactive power references “Pref, Qref” are divided over the other non-faulty battery systems 210, 230, 240, by their respective control parameters, i.e. by their respective active and reactive power setpoints P1, Q1; P3, Q3; P4, Q4, such that the energy storage system 200 can provide the demanded active and reactive power “Pref, Qref”.

Testing of the battery condition, followed by updates and calibration based on the testing, is very important in any battery system. Typically, the battery condition test is performed such that a state of charge (SOC) and/or a state of health (SOH) is determined for at least one of the one or more battery units 222 of the faulty battery system 220. The battery condition test may include battery profiling under controlled conditions, such as by providing a well-defined/controlled current to the battery unit 222, where this current is unrelated to the demanded active and reactive power “Pref, Qref”. The faulty battery system 220 may here, for example, be controlled by its active and reactive power setpoints P2, Q2, to perform tests related to the above-mentioned model. Thus, the model may be determined during testing controlled according to this embodiment.

According to some embodiments, the in this document mentioned control parameters P1, Q1; P2, Q2; P3, Q3; P4, Q4, used for controlling the battery systems 210, 220, 230, 240, respectively, comprise active power setpoints and/or reactive power setpoints. Essentially, any control signal denotation, such as control parameters, control signals, setpoints, reference values and/or references, may be used for these control parameters, as long as the denotation is used according to the herein presented definition. Thus, the control parameters are by a central controller 260, at essentially any level in the energy storage system 200, used for controlling two or more battery systems 210, 220, 230, 240, each battery system comprising one or more power conversion system unit 213, 223, 233, 243 associated with at least one battery unit 212, 222, 232a-c, 242, and at least one local controller 211, 221, 231, 241. The battery systems 210, 220, 230, 240 may also comprise at least one functional unit 214, 224, 234, 244, such as a cooling system or the like.

According to various embodiments, the information M related to the at least one operation limitation, i.e. the information provided to the central controller 260 from the battery systems 210, 220, 230, 240, comprises information related to an actual state of the least one battery system 220, such as e.g. a performance of the cooling system 224, a uniformity of rack status of the battery unit 222 (i.e. statuses of individual batteries in a rack of a plurality of batteries) and/or an off gas condition of the battery unit (i.e. degrading batteries emitting flammable gasses).

According to further embodiments, the information M may also comprise information related to a maximal active power capability of the least one battery system 220, such as a condition of at least one power conversion system unit 223 of the least one battery system 220 a thermal performance of the battery unit 222 and/or an insulation status of the least one battery system 220, which may be reported by an insulation monitoring/measuring device.

According to an embodiment, the determination 420 of the control parameters P1, Q1; P2, Q2; P3, Q3; P4, Q4 for the two or more battery systems 210, 220, 230, 240, respectively, may also be based on a state of charge (SOC) and/or a state of health (SOH) for the battery units 212, 222, 232a-c, 242. Hereby, a uniform or non-uniform state of charge may be achieved by utilizing or excluding certain battery systems/units or parts of certain battery systems/units. Also, a uniform state of health degradation for the energy storage system 200 may be achieved by excluding certain battery/systems units or parts of certain battery units.

The above-described determination 420 of the control parameters P1, Q1; P2, Q2; P3, Q3; P4, Q4 for the two or more battery systems 210, 220, 230, 240, respectively, thus provides for a condition-based distribution of control parameters P1, Q1; P2, Q2; P3, Q3; P4, Q4 to the two or more battery systems 210, 220, 230, 240. The actual condition of the faulty battery system, and how this condition would affect the battery system over time, is by the determination 420 taken into consideration in the distribution. Thanks to this condition-based distribution, a remaining useful power to be provided by the two or more battery systems 210, 220, 230, 240 over time, is divided between the two or more battery systems 210, 220, 230, 240, while exploring the at least one operation limitation of the at least one faulty battery system 220.

According to a second aspect of the invention, a central controller 260 of an energy storage system 200 is presented. The central controller 260 is configured to control two or more battery systems 210, 220, 230, 240, of which at least one battery system 220 has at least one operation limitation. For example, the faulty battery system 220 may have a functional unit 224, such as a cooling system, a battery unit 222, or a power conversion system unit 223 which is not working properly, e.g. is out of order or is at least partly defect in any way.

When at least one battery system 220 is at least partly faulty, the central controller 260 is configured to obtain 410 information M related to the at least one operation limitation from the at least one battery system 220, as described in detail above.

The central controller 260 is further configured to determine 420, based on the obtained information M, control parameters P1, Q1; P2, Q2; P3, Q3; P4, Q4 for the two or more battery systems 210, 220, 230, 240, respectively. This determination of the control parameters P1, Q1; P2, Q2; P3, Q3; P4, Q4 takes into account an estimation of how the at least one battery system 220 with the at least one operation limitation will behave over time when being controlled by its control parameters P2, Q2, as explained in detail above.

The central controller 260 is further configured to provide 430 the control parameters P1, Q1; P2, Q2; P3, Q3; P4, Q4 to the two or more battery systems (210, 220, 230, 240), respectively.

According to a third aspect of the present invention, which is illustrated partly in FIG. 1, a power plant 100 is presented. The power plant is arranged/configured to provide electric power produced in the power plant to an electric power grid 102. The power plant 100 comprises one or more electric power generating units 103, two or more battery systems 210, 220, 230, 240, and a herein described central controller 260 configured to control the two or more battery systems 210, 220, 230, 240.

The person skilled in the art will appreciate that the herein described method aspects and embodiments of the central controller 260 for controlling two or more battery systems 210, 220, 230, 240 may also be implemented in a computer program, which, when it is executed in a computer, instructs the computer to execute the method. The computer program is usually constituted by a computer program product 503 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

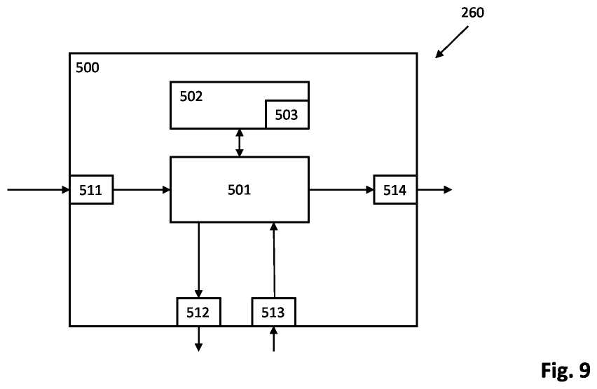

FIG. 9 shows in schematic representation an embodiment of the central controller 260 according to an aspect of the invention, which may include a control unit 500, which may be arranged/configured for performing/executing one or more of the above-mentioned method steps 410, 420, 430. The control unit 500 may comprise a computing unit 501, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 501 is connected to a memory unit 502 arranged in the control unit 500. The memory unit 502 provides the computing unit 501 with, for example, the stored program code and/or the stored data which the computing unit 501 requires to be able to perform computations. The computing unit 501 is also arranged to store partial or final results of computations in the memory unit 502.

In addition, the control unit 500 may be provided with devices 511, 512, 513, 514 for receiving and transmitting input and output signals. These input and output signals may comprise waveforms, impulses, or other attributes which, by means of the devices 511, 513 for the reception of input signals, can be detected as information and can be converted into signals which can be processed by the computing unit 501. These signals are then made available to the computing unit 501. The devices 512, 514 for the transmission of output signals are arranged to convert signals received from the computing unit 501 in order to create output signals by, for example, modulating the signals, which, for example, can be transmitted to other parts and/or systems of, or associated with, the electric power grid 102 and/or the power plant 100 (see FIG. 1). Each of the connections to the devices for receiving and transmitting input and output signals can be constituted by one or more of a cable, a data bus, and a wireless connection.

Here and in this document, control units are often described as being provided for performing steps of the method according to herein described aspects and embodiments of the invention. This also includes that the units are designed to and/or configured to perform these method steps. For example, the control units may comprise one or more control entities arranged for performing one or more of the herein described method steps 410, 420, 430, respectively. These control entities may for example correspond to groups of instructions, which may be in the form of programming code, that are input into, and are utilized/executed by the processor/computing unit 501 of the control unit 500 when the entities are active and/or are utilized for performing their method steps, respectively. Such control entities may be implemented as separate entities in multiple control units, or may be logically separated but physically implemented in the same control unit, or may be both logically and physically arranged together.

With reference to FIGS. 2 and 3, the central controller 260, which may include one or more control units or control entities, such as for example one or more devices, controllers or control devices, may be arranged to perform all of the method steps mentioned above, in the claims, and in connection with the herein described aspects and embodiments. The central controller 260 is associated with the above-described advantages for each respective embodiment of the method.

The present invention is not limited to the above-described embodiments. Instead, the present invention relates to, and encompasses all different embodiments being included within the scope of the independent claims.

1. A method of a central controller of an energy storage system for controlling two or more battery systems, wherein at least one of the two or more battery systems has at least one operation limitation,
the method comprising:
obtaining information (M) related to the at least one operation limitation from the at least one battery system;
determining, based on the information (M), control parameters for the two or more battery systems, respectively, taking into account an estimation of how the at least one battery system with the at least one operation limitation will behave over time when being controlled by its control parameters; and
providing the control parameters to the two or more battery systems, respectively.

2. The method as claimed in claim 1, wherein
the determination of the control parameters is performed such the at least one battery system with the at least one operation limitation is controlled to only be utilized during one or more of limited time periods and limited peak powers.

3. The method as claimed in claim 1 wherein
the at least one operation limitation is associated with an at least partially malfunctioning cooling system of the at least one battery system; and
the determination of the control parameters is performed such that overheating of the at least one battery system with the at least one operation limitation is avoided when it is controlled by its control parameters.

4. The method as claimed in claim 3, wherein
the determination of the control parameters is based on a model, wherein the model describes how a temperature of the at least one battery system, due to the at least partially malfunctioning cooling system (224), will vary over time as a function of its control parameters.

5. The method as claimed in claim 4, wherein the model is used for one of the group of:
a determination of the information (M) related to the at least one operation limitation; and
the determination of the control parameters, utilizing the information (M) related to the at least one operation limitation as an input to the model.

6. The method as claimed in claim 1, wherein
the at least one operation limitation is associated with the at least one battery system having a limited capability to provide active power; and
the determination of the control parameters is performed such that the at least one battery system with the at least one operation limitation is controlled to provide active power corresponding to its limited active power capability, and such that at least one power conversion system unit of the at least one battery system, respectively, is controlled to provide reactive power.

7. The method as claimed in claim 6, wherein the at least one battery system is used for static synchronous compensation.

8. The method claimed in claim 1, wherein
the determination of the control parameters is performed such that the at least one battery system with the at least one operation limitation is controlled to be inactivated in order to reduce an auxiliary power consumption of the energy storage system.

9. The method as claimed in claim 1, wherein
the determination of the control parameters is performed such that the at least one battery system with the at least one operation limitation is controlled to perform a battery condition test.

10. The method as claimed in claim 1, wherein the control parameters comprise one or more of the group of:
active power setpoints; and
reactive power setpoints.

11. The method as claimed in claim 1, wherein the information (M) related to the at least one operation limitation comprises information related to one or more of the group of:
an actual state of the least one battery system;
a performance of a cooling system of the at least one battery system;
a uniformity of rack status of a battery unit of the at least one battery system;
an off gas condition of a battery unit of the at least one battery system;
a maximal active power capability of the least one battery system;
a condition of at least one power conversion system unit of the least one battery system;
an insulation status of the least one battery system; and
a thermal performance of a battery unit of the at least one battery system.

12. The method as claimed in claim 1, wherein
the determination of the control parameters for the two or more battery systems, respectively, provides for a condition-based control parameter distribution of a remaining useful power between the two or more battery systems over time, taking into account the at least one operation limitation of the at least one battery system.

13. (canceled)

14. A central controller of an energy storage system configured to control two or more battery systems, where at least one of the two of more battery systems has at least one operation limitation, wherein the central controller is configured to:
obtain information (M) related to the at least one operation limitation from the at least one battery system;
determine, based on the information (M), control parameters for the two or more battery systems, respectively, taking into account an estimation of how the at least one battery system with the at least one operation limitation will behave over time when being controlled by its control parameters; and
provide the control parameters to the two or more battery systems, respectively.

15. A power plant configured to provide electric power to an electric power grid, wherein the power plant comprises:
one or more electric power generating units;
two or more battery systems wherein at least one of the two or more battery systems has at least one operation limitation; and
a central controller configured to perform an operation, comprising:
obtaining information (M) related to the at least one operation limitation from the at least one battery system;
determining, based on the information (M), control parameters for the two or more battery systems, respectively, taking into account an estimation of how the at least one battery system with the at least one operation limitation will behave over time when being controlled by its control parameters; and
providing the control parameters to the two or more battery systems, respectively.
